(19) United States
(12) Patent Application Publication
(10) Pub. No.: US 2024/0090486 A1
(43) Pub. Date: Mar. 21, 2024

(54) DEVICE, SYSTEM, AND METHOD FOR ATTACHING FISHING LINE TO A FISHING IMPLEMENT

(71) Applicant: WESTWATER PRODUCTS, LLC, Pleasant Grove, UT (US)

(72) Inventors: Brian Westover, Pleasant Grove, UT (US); King Shung Choi Gauss, Hong Kong (HK)

(73) Assignee: WESTWATER PRODUCTS, LLC, Pleasant Grove, UT (US)

(21) Appl. No.: 17/932,611

(22) Filed: Sep. 15, 2022

(51) Int. Cl. A01K 91/04

(52) U.S. Cl. CPC A01K 91/04

(57) ABSTRACT

Devices, systems, and methods for attaching a fishing line to a fishing implement. The device may comprise a housing comprising and upper portion and a lower portion. The device may comprise a cam pivotably disposed about the housing. The upper portion of the housing may comprise a cavity configured to receive the cam therein. The cam is configured to rotate within the cavity from an unlocked position to a locked position and from the locked position to the unlocked position.

### TECHNICAL FIELD

This disclosure is directed to devices, systems, and methods for attaching a fishing line to a fishing implement. More specifically, this disclosure is directed, but not necessarily entirely, to fly-fishing devices, system, and methods for attaching a fly-fishing line to a fishing implement.

### BACKGROUND

In fly fishing, a small substantially weightless hooked lure which resembles a fly or other bug is cast into the water. Normally the lure is attached to a monofilament “leader.” which is virtually transparent in the water. The leader is attached to a line, which is usually opaque. For most species of fish, the fly fisherman uses either a surface-type fly or one that swims underwater. Disregarding trout flies, for the moment, most other flies used to take fish in salt and fresh water fall into two categories: popping bugs that sit on the surface and are designed to make noise, and streamers which are underwater flies and are designed to imitate baitfish or leeches. Among the most popular surface-type flies for trout are conventional dry flies, terrestrial, thorax, paradun, parachute. Griffin's Gnat style, no-hackle, spinner, Renegade or fore and aft style, skater, variant, caddis and stonefly. Underwater flies for trout include wet flies, nymphs, soft hackle flies and streamers.

When a lure is cast into the water, a fish may attack the lure for a variety of reasons including instinct, anger or hunger, during which time an angler has an opportunity to set the hook. If the lure floats unnaturally in the water or if the line or lure makes a big splash, the fish may be spooked and seek cover, avoiding the lure. Assuming that the fish attacks the lure, for the angler to hook the fish he or she must know that it is mouthing the lure. If the angler is using a surface-type fly, the line, leader and fly are all on the surface of the water and it is easier for the angler to make a strike at the appropriate moment. It is for this reason that most people prefer dry fly fishing for trout.

Trout and many other fish, however, feed underwater nearly all of the time and are more likely to be taken on a lure that swims under the water. Knowing when a fish has taken a wet fly, nymph or the like is traditionally done by feel and takes a great deal of training to perfect. When an underwater fly is used in fly-fishing, the strike of a fish is often difficult to detect. Fly-fishermen began using strike indicators attached to the leaders of their fly lines to better detect when a fish strikes their fly.

Typically, a fly is cast upstream and is fished back downstream to the fisherman. The fly typically moves naturally with the current downstream towards the fisherman. The fisherman often utilizes a floating strike indicator to help track the progress of the fly downstream. If a fish bites or eats the fly, motion will be imparted on the strike indicator that is inconsistent with the current. For example, the strike indicator may be pulled underwater by the fish, or the strike indicator may move upstream instead of downstream, or it may move cross-current, etc. When the fisherman notices this inconsistent movement; the fisherman will attempt to quickly set the hook embedded in the fly (or other lure) through a quick movement or manipulation of the fishing pole. The fisherman must attempt to set the hook very quickly in the mouth of the fish or risk giving the fish time to determine that the lure is a hook or other fishing device, whereby the fish would allow the fly to move out of its mouth.

Strike indicators attempt to signal the moment that the fly has been eaten by the fish. The fisherman must maintain a balance between letting the fly float naturally with the current and keeping the line taught enough to deliver a quick, sharp hook set. Beginning fly-fishermen find this very difficult and experienced fly-fishermen never fully master the technique.

While useful, strike indicators known in the art have a weakness characterized by a difficulty in attaching them to a fishing line. Other inventions in the art require meticulous line threading and tying or tediously opening and closing a mechanism with small parts that could easily be lost. Attachment-styles in the form of weight screws, slit screws, depth screws, and magnetic attachments are the norm in the art, thus there still exists a need for a quick and convenient attachment mechanism that is devoid of small parts that may be dropped or lost.

It is noteworthy that none of the devices known to applicant provides a mechanism to attach a strike indicator to a fishing line quickly, easily, and securely. There is a long felt, but currently unmet need, for a line securing device that is inexpensive to make and simple in operation.

The known devices are thus characterized by several disadvantages that are addressed by the disclosure. The disclosure minimizes, and in some aspects eliminates, the above-mentioned failures, and other problems, by utilizing the structural features and methods described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regards to the following description and accompanying drawings where:

FIG. 1A is a side view of an exemplary fly fishing camlock device illustrating a first side of the camlock device made in accordance with the principles of the disclosure;

FIG. 1B is an opposite side view of an exemplary fly fishing camlock device with a focus on a second side of the camlock device made in accordance with the principles of the disclosure;

FIG. 1C is a front view of an exemplary fly fishing camlock device made in accordance with the principles of the disclosure;

FIG. 1D is an overhead top view of an exemplary fly fishing camlock device made in accordance with the principles of the disclosure;

FIG. 1E is a rear view of an exemplary fly fishing camlock device made in accordance with the principles of the disclosure;

FIG. 2A is a cross-sectional side view of an exemplary fly fishing camlock device with a cam and insert disposed therein and made in accordance with the principles of the disclosure;

FIG. 2B is a cross-sectional opposite side view of an exemplary fly fishing camlock device with a cam and insert disposed therein and made in accordance with the principles of the disclosure;

FIG. 3A illustrates various views of a first member of an exemplary fly fishing camlock device made in accordance with the principles of the disclosure;

FIG. 3B illustrates various views of a second member of an exemplary fly fishing camlock device made in accordance with the principles of the disclosure;

FIG. 4 illustrates various views of an insert of an exemplary fly fishing camlock device made in accordance with the principles of the disclosure;

FIG. 5 illustrates various views of a cam of an exemplary fly fishing camlock device made in accordance with the principles of the disclosure;

FIG. 6A is a side view of another exemplary fly fishing camlock device made in accordance with the principles of the disclosure;

FIG. 6B is a reverse-side view of the exemplary fly fishing camlock device of FIG. 6A made in accordance with the principles of the disclosure;

FIG. 6C is an overhead top view of the exemplary fly fishing camlock device of FIG. 6A made in accordance with the principles of the disclosure;

FIG. 6D is an overhead perspective view of the exemplary fly fishing camlock device of FIG. 6A made in accordance with the principles of the disclosure;

FIG. 7A illustrates a fly fishing camlock device and a body made in accordance with the principles of the disclosure;

FIG. 7B illustrates a fly fishing camlock device and body forming a complete fly fishing camlock system made in accordance with the principles of the disclosure;

FIG. 7C illustrates a fly fishing camlock system attached to a fishing line made in accordance with the principles of the disclosure; and

FIG. 8 illustrates a method of securing a fly fishing camlock device to a fishing line in accordance with the principles of the disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present structural features and methods are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

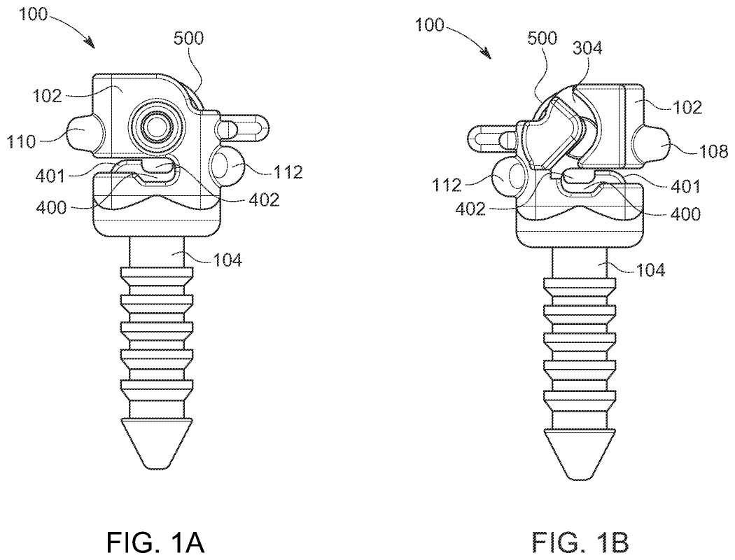

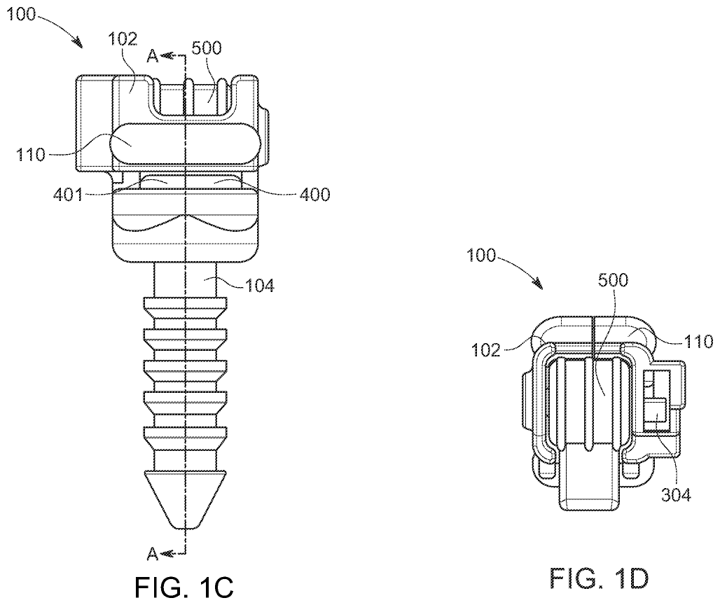

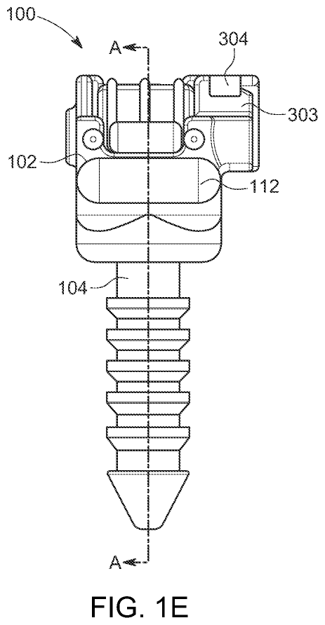

Broadly, with reference to FIGS. 1A-IE, the disclosure relates to a fly fishing camlock device 100. The device 100 may be manufactured in a single piece construction or may be manufactured of a plurality of individual pieces that are attached or connected together to form one solid or unitary device 100. FIG. 1A shows an implementation of a fly fishing camlock device 100 according to the disclosure as seen from a side view showing a first member 200. A fly fishing camlock device 100 may comprise an upper portion 102 and a lower portion 104. The upper portion 102 may have a front protrusion 110 on a front-facing face of the upper portion 102 and a rear-protrusion 112 on another face to facilitate easier grip of the device 100. These protrusions 110 and 112 may include a groove therein that may be used to receive a pin or other locking mechanism to secure each half of the device together when snapped together. A cam 500 or other suitable securing means may be disposed within the upper portion 102. A cam may be rotatably operated via a cam lever 502 that extends away from an upper portion 102. The cam lever 502 may be situated in such a way as to be easily accessible to and operated by a finger or another tool that could be used to operate a locking mechanism. The lower portion 104 may have a plurality of ribs 106 spaced some distance apart, terminating in a wedge 108 at a distal end of the lower portion 104. The ribs 106 may be shaped and sized so as to have an interference fit with a body of a strike indicator (not shown). The body may comprise a substantially spherical or other suitable shape comprised of a foam or other buoyant material. In some implementations the body may have a hollow interior configured to trap a fluid in order to float as part of a fly fishing apparatus. The wedge 108 may comprise a cone or other shape suited for fitting into a body.

In order to provide an appropriate balance between durability and weight, the fly fishing camlock device may be manufactured from a lightweight, durable material having a sufficient thickness to be durable. For example, the lightweight material may be a lightweight thermoplastic material and may advantageously provide the avoidance of a big splash as the fishing lure is cast into the water, thereby avoiding the problem of spooking the fish due to the big splash. Further due to the lightweight material, the fly fishing camlock device 100 may be light enough to not interfere with a user's cast while being durable enough to withstand the impact of water over the course of many casts.

It will be appreciated that any lightweight material may be utilized by the disclosure without departing from the spirit or scope of the disclosure. However, it has been found advantageous to use one of the following lightweight materials, including, but not limited to, thermoplastic elastomers, also known as TPEs, and vinyl acetate copolymers, for example ethylene vinyl acetate (also known as EVA). It will be appreciated that the fly fishing camlock device generally, and some or all parts therein of the disclosure, may be manufactured from any family of polymers that can be elastically durable, meaning that the material may repeatedly experience forces such as being cast or impacting a fluid surface without deforming or damaging the shape of the part. It will be appreciated that due to the lightweight material from which the fly fishing camlock device may be manufactured, the fly fishing camlock device may be resilient, such that the fly fishing camlock device may retain its shape and durability under reasonable pressure exerted by normal use.

Thermoplastic elastomers (TPEs) may be processed by conventional thermoplastic techniques such as injection molding, extrusion and blow molding. It will be appreciated that there are several main thermoplastic elastomer groups found commercially, for example: styrenic block copolymers, polyolefin blends (TPOs), elastomeric alloys, thermoplastic polyurethanes (TPUs), thermoplastic copolyesters and thermoplastic polyamides.

Vinyl acetate copolymers, such as ethylene vinyl acetate, are commercially available from various commercial sources. For example, DuPont manufactures ethylene vinyl acetate under the brand name ELVAX®. It will be appreciated that the lightweight material used to manufacture the fly fishing camlock device of the disclosure may also have good resistance to water, which may be advantageous for the intended use of the fly fishing camlock device. It will be appreciated that because vinyl acetate copolymers, such as EVA, are thermoplastics, they can be easily molded by extrusion, injection, blow molding, and rotational molding.

Some or all parts of a fly fishing implement, including a fishing implement body, may be comprised of foam or another buoyant material. For example, the foam may be manufactured or made from ethylene-vinyl acetate (EVA) or other similar material. Foams are materials formed by trapping pockets of gas in a liquid or solid. A foam is, in many cases, a multi-scale system. One scale is the bubble: material foams are typically disordered and have a variety of bubble sizes. At larger sizes, the study of idealized foams is closely linked to the mathematical problems of minimal surfaces and three-dimensional tessellations, also called honeycombs. The Weaire-Phelan structure is considered the best possible (optimal) unit cell of a perfectly ordered foam, while Plateau's laws describe how soap-films form structures in foams.

Solid foams are a class of lightweight cellular engineering materials. These foams are typically classified into two types based on their pore structure: open-cell-structured foams (also known as reticulated foams) and closed-cell foams. At high enough cell resolutions, any type can be treated as continuous or “continuum” materials and are referred to as cellular solids, with predictable mechanical properties.

Turning now to FIGS. 1A-1E, a fly fishing camlock device 100. FIG. 1A shows an implementation of a fly fishing camlock device 100 according to the disclosure as seen from a side view showing a first member 200. A fly fishing camlock device 100 may comprise an upper portion 102 and a lower portion 104. In some implementations the upper portion may be a substantially cubic shape, while in others it may be substantially spherical, resembling a trapezoidal prism, or any other 3D shape suited to house a cam or similar securing means. In some implementations the lower portion may comprise a substantially cylindrical shape, but in others it may be a rectangular prism, a pyramid, or another shape suited for support. A cam 500 or other suitable securing means may be disposed within the upper portion 102. Located within the upper portion 102 may be a recess having a space comprising a cavity 218. A cavity 218 may have a narrow cavity opening 216 near a bottom end of the upper portion 102 and have an insert 400 member within. An insert 400 may be a substantially square shape having a recess 402 disposed near the center of a top surface of an insert 400. This insert with recess may be configured such that a fishing line or similar object may slide easily into the cavity opening 216 and “hook” around an edge 404 formed by the insert recess 402 in order to secure the line and prevent it from slipping out of the cavity opening 216. It will be appreciated that as used herein, the phrase “fishing line” includes a fly line and/or a fishing leader. In some implementations the line may be fed through the cavity opening 216 and recess laterally, as though threading a needle. In others the line may be inserted by sliding a line into the cavity and recess which are designed to resist insertion slightly. With some slight force a user may “pop” the line into the narrow cavity opening 216 as though flossing a tooth. Once inserted the recess and cavity together are configured to resist removal of the line back through the cavity opening 216 as though flossing, but not resist removal as though unthreading a needle.

The cam 500 may be rotatably operated via a cam lever 502 that may extend away from the upper portion 102. The cam lever 502 may be situated in such a way as to be easily accessible to and operated by a finger or another tool that could be used to operate a lever-like locking mechanism. The lower portion 104 may have a plurality of ribs 106 spaced some distance apart, terminating in a wedge 108 at a distal end of the lower portion 104. The ribs 106 may be shaped and sized so as to have an interference fit with a body or other accessory or attachment. The body may comprise a substantially spherical or other suitable shape configured to float as part of a fly fishing apparatus. The wedge 108 may comprise a cone or other shape suited for fitting into a body.

FIG. 1B. shows a reverse side view of a fly fishing camlock device 100 showing a second member 300. A second member 300 may be joined to the first member to form a complete fly fishing camlock device 100. While a device comprised of two members is shown as an implementation of the present disclosure, other configurations of less or more members are contemplated. A second member 300 may lack a wedge 108 as may be located at a distal end of a lower portion of the first member. A second member may have a channel protrusion 303 extending laterally from the upper portion, which may comprise a cam channel 304. The channel protrusion 303 and cam channel 304 may be sized to interface flush with a cam 500, whereby a cam arm 504 may be disposed within the channel protrusion 303 and may have enough space to rotate within the cam channel 304. A fishing line or similar object may be fed through a cam channel 304 and may be trapped within a cam channel by a cam arm 504 after rotating a cam 500. In doing so, a user may secure a fishing line to keep it in place and reduce slippage, thus securing the fishing line to the fly fishing camlock device 100. The fishing line may be substantially straightened by interacting with the cam channel 304 in this way such that the fishing line would travel straight down, or substantially parallel to a longitudinal axis of the lower portion 104, into a body of water once cast.

FIGS. 1C, 1D, and 1E show alternative views of a fly fishing camlock device 100. FIG. 1C shows a front-facing view of the fly fishing camlock device. A second member 300 may attach flush with the first member 200 to form a complete device 100. A longitudinal axis A-A of the device exists within the fly fishing camlock device 100. When attached, a lower portion 104 of second member 300 may rest with a wedge 108 of the first member 200. In some implementations, a cavity opening 216 may span the width of the upper portion 102 and an insert 400 disposed within the cavity 218 may span the width the cavity 218. In other implementations the insert 400 may span some width less than the full width of the cavity 216. FIG. 1D shows a top overhead view, in which a cam 500 may be disposed within the upper portion 102 in a space formed by a joined first member 200 and second member 300. The cam 500 may have one or more raised lines comprising cam grooves 506, ribs, or similar raised protrusions extending along a top portion of the cam 500 to provide grip and enable smooth operation of rotatably operating the cam 500 to or from a locked position (not shown). The cam 500 may comprise a curved surface 508 and a substantially flat surface 510. FIG. 1E shows a rear view, where a cam lever 502 may protrude from the cam 500 away from the upper portion 102 of a fly fishing camlock device 100. In an unlocked position as shown in the figures, a cam lever 502 may rest in a position parallel to a horizontal plane of the upper portion 102.

To move from an unlocked position to a locked position, a user may apply force to the cam lever 502 to rotatably operate the cam 500. The cam may pivot within the upper portion 102 such that the cam lever 502 rotates upward, thereby rotating a cam arm 500 disposed within the cam channel 304 into such a position that the irregular shape of the cam's curved surface 508 and the cam arm 504 fills space within the recess 402 cam channel 304 respectively, preventing any fishing line or similar within the channel from escaping or otherwise slipping out, thus securing the fishing line. The curved surface 508 may be configured to be rounded to such a degree that the curved surface makes contact with the raised edge 404 to “close” the open space from the top of the insert 400.

To move from a locked position to an unlocked position, a user may apply force to a raised cam lever to rotate the cam back to a parallel position, rotating the cam curved surface 508 cam arm 504 out of the spaces of the recess 402 and the cam channel 304 respectively, to allow any fishing line or similar therein to be removed.

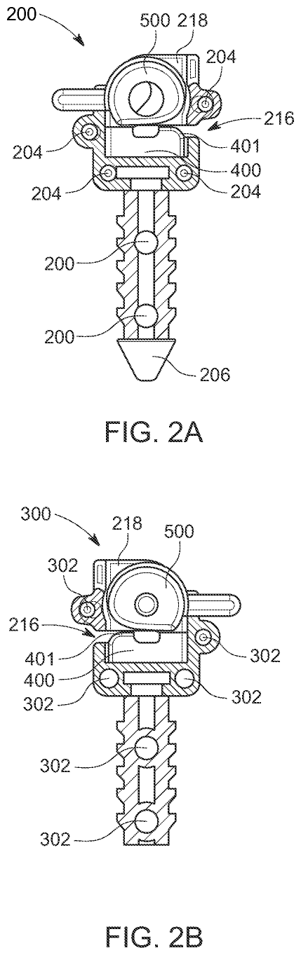

FIG. 2A shows a cross-sectional view of an implementation of a fly fishing camlock device 100 according to the disclosure, focusing on a first member 200. A first member 200 may be configured in such a way as to have cavities within the upper portion 102 and lower portion 104. The lower portion 104 may have a plurality of ribs 106 sized and spaced to be configured to have an interference fit with a body of a strike indicator. The lower portion 104 may terminate in a wedge 108. The upper portion 102 and cavity 216 within may be configured such that a cam 500 and insert 400 may both be disposed within the cavity 216 and interface with one another. The top surface of the insert 400 may be raised such that, when disposed within the cavity 218 of a fly fishing camlock device, the top surface of the insert 400 and a surface of the upper portion along the top of the cavity opening 216 may create a narrow opening. This opening may be narrow enough such that a line or similar object may be fed into the cavity with slight resistance, but could not be easily removed in the same way. This may allow a fly fishing camlock device to be easily attached to a line in a secure enough manner to prevent the device inadvertently falling off while still being slid or otherwise moved up or down a length of the line. FIG. 1B shows a cross sectional view of an implementation of a fly fishing camlock device 100 according to the disclosure focusing on a second member 204. Similar to the first member 200, the second member 204 may have a plurality of ribs 106

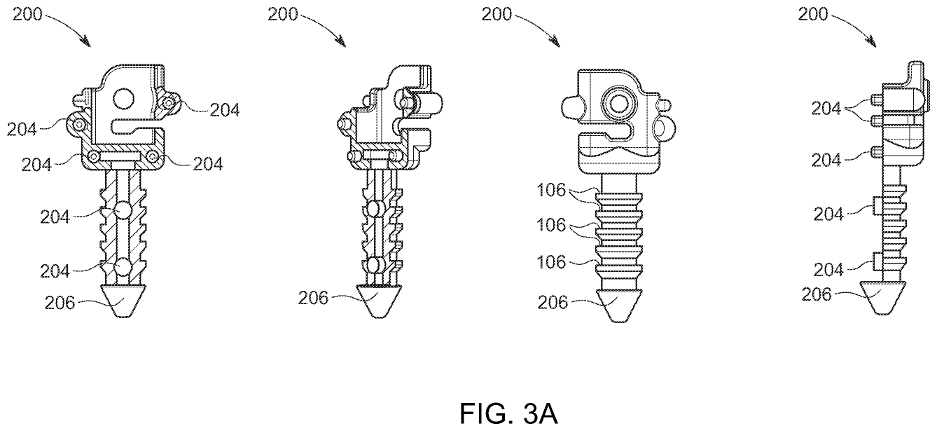

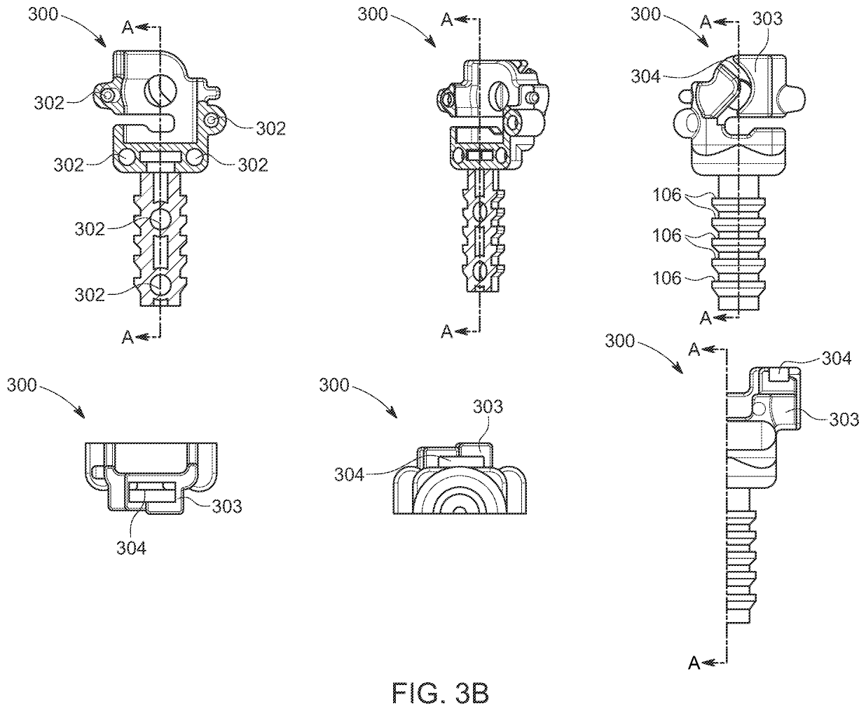

FIG. 3A shows a standalone first member 200 of an implementation according to the principles of the disclosure from multiple viewing angles. A first member 200 may have a recess in the upper portion 102 and may have a recess in the lower portion 104 to reduce unnecessary material and reduce overall weight. In an implementation, the first member 200 may additionally have a plurality of snap members 204 dispersed within an inner surface of the first member. In other implementations, instead of using the snap members 204 other comparable attachment mechanisms may be used. Snap members 204 may be a circular shape in some implementations, and in others may be square pegs, or some other shape matching the recesses of snap recesses 302. A first member 200 may have a wedge 108 located at a distal end of the lower portion 104. In some implementations the wedge 108 may comprise a conical shape, in others it may comprise a pyramid or other wedging shape.

FIG. 3B shows a second member 300 of an implementation according to the principles of the disclosure from multiple viewing angles. A second member 300 may have a recess an upper portion 102 and may have a recess in a lower portion 104 to reduce unnecessary material and reduce overall weight. A plurality of snap recesses 302 may be disposed around an edge of the second member 300 and configured to mate with snap members 204 of a first member 200 via snap-together coupling to form a complete fly fishing camlock device 100. A second member 300 may have a protrusion 303 comprising a cam channel 304 extending laterally from the upper portion 102. The cam channel 304 may comprise a C-channel in some implementations and other comparable shapes in other implementations. The channel may be configured to interface with a cam 500 such that a cam arm 504 may fit within the cam channel 304 and rotate into a position to secure a fishing line. A longitudinal axis A-A of the device as a whole but specifically the second member 300 is also shown in FIG. 3B.

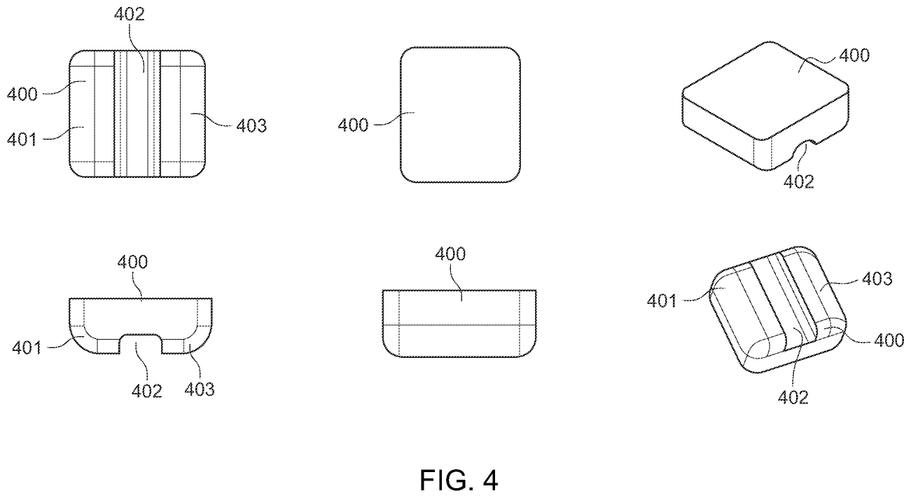

FIG. 4 shows an insert 400 according to the principles of the disclosure. In some implementations, the insert 400 piece may be made from a plastic material or another other suitable polymer material. The insert 400 may have square, rectangular, or other shape base designed to fit within a cavity of a fly fishing camlock device. In an implementation, a top surface of the insert 400 may have an insert recess 402 disposed within the top surface, resulting in a top surface having a hook or similar edge configured to “catch” a fishing line fed across it, such that the line is secured and not able to easily slip out of the cavity of the fly fishing camlock device when pulled taught. In some implementations the recess 402 may be disposed central to the top surface of the insert 400. In other implementations the recess 402 may be located anywhere on a top surface of the insert 400 or located elsewhere on a surface of the insert 400. An insert 400 may have more than recess 402 on more than one surface. The top surface may be rounded on each edge in some implementations, and in others one edge may remain substantially squared for manufacturing convenience. The insert 400 may comprise one or more surfaces 401 and 403 that may be shaped sufficiently to allow the fishing line to inserted into the recess 402. It will be appreciated that the surfaces 401 and 403 may be rounded or may be any other suitable shape to aid the entry of the fishing line into the recess 402. The insert 400, and particularly the recess 402, may be sufficiently shaped to allow easy entry of the fishing line into the recess 402. However, once the fishing line is located within the recess 402, the shape of the recess 402 also assists in maintaining the fishing line within the recess 402 without an external force applied. When an external force is applied to the fishing line when located within the recess 402, the fishing line may overcome any resistance from the recess 402 and exit.

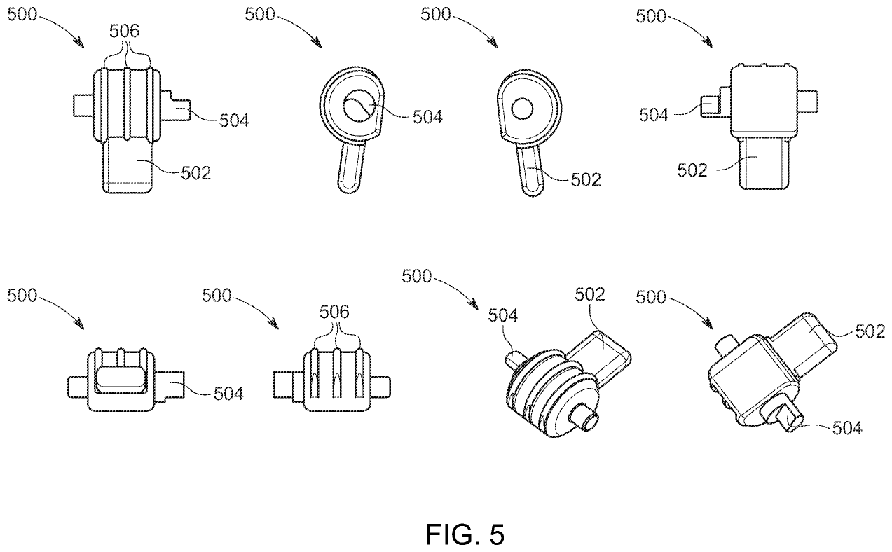

FIG. 5 shows a cam 500 according to the principles of the disclosure. In some implementations a cam may have rounded, cylindrical-like shape with one or more protrusions comprising arms 504 extending laterally from one or more side faces of the cam 500. In some implementations, a cam 500 may have a member extending from rear of cam 500 comprising a cam lever 502 to operate the cam 500 once disposed within a fly fishing camlock device 100. A cam 500 may have raised ridges comprising cam grooves 506 of a same or different material as the cam that are configured to interface with the fly fishing camlock device 100 to allow the cam to rotate smoothly and with enough resistance to secure the cam in a locked position, while still able to operate easily. The cam may have a curved surface 508 and a substantially flat surface 510 making up the irregular shape of the cam.

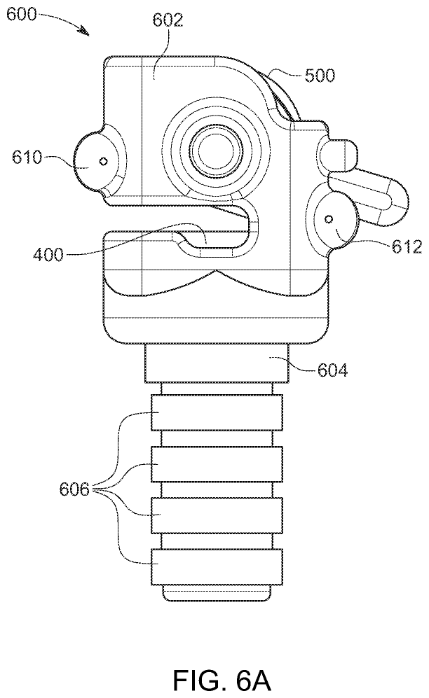

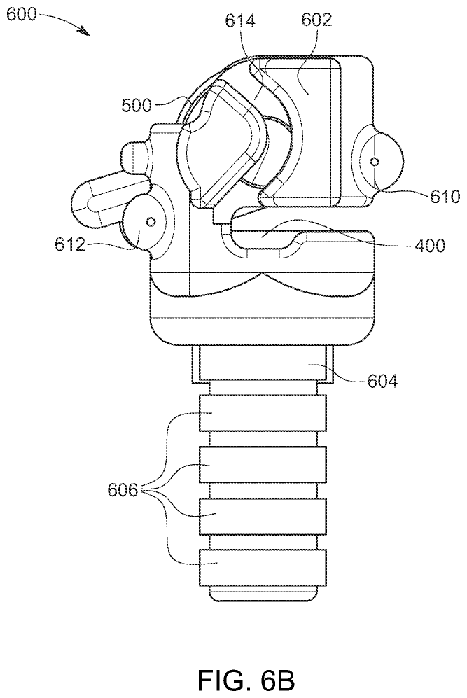

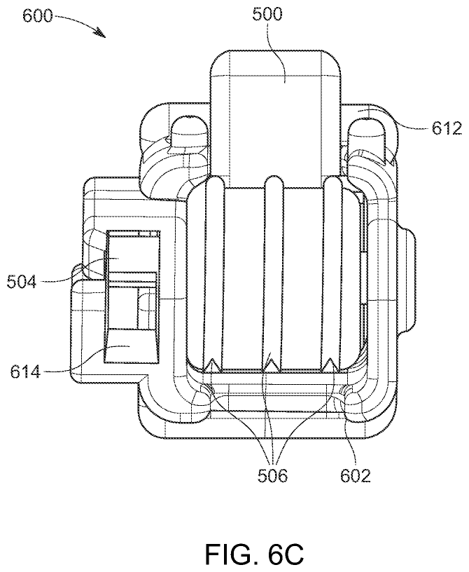

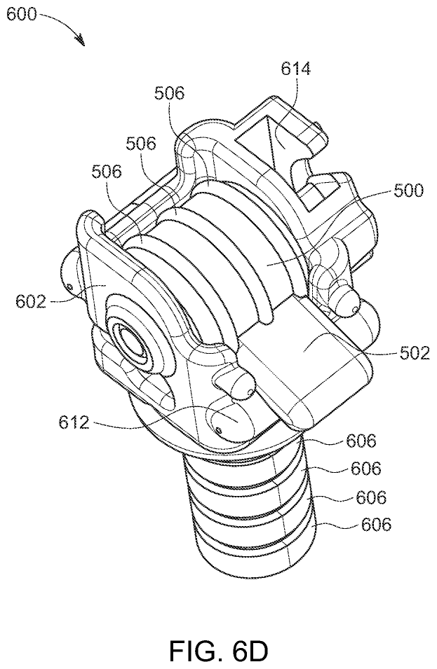

FIGS. 6A-6D show an exemplary fly fishing camlock device 600 according to the principles of the disclosure from multiple viewing angles. FIGS. 6A and 6B show a side view and a reverse side view comparable. The fly fishing camlock device 600 may have an upper portion 602 having a front protrusion 610 and a rear protrusion 612. The device 600 may additionally have a lower portion 604 having a plurality of rib ridges 606 spaced along a length of the lower portion. A cam 500 and an insert 400 may be disposed within the upper portion 602. The device 600 may additionally have a channel 614 on one or both sides of the device configured to interface with the cam 500. FIG. 6C shows a top overhead view offering a clearer view of how the cam 500 may be seated within the upper portion 602. A cam arm 504 may extend into the channel 614 in order to interface with any fishing line fed through the channel 614. FIG. 6D shows a rear perspective view offering a clearer view of how a cam 500 may be seated within an upper portion 602. In an implementation of the present disclosure, the fly fishing camlock device 600 may be overall smaller and stockier in comparison to other implementations. The lower portion may be shorter and thicker and the rib ridges 606 of the lower portion 604 may be thicker and spaced closer together. Front protrusions 610 and rear protrusions 612 may be sized smaller than some implementations. The cam lever 502 of the cam 500 may rest in an unlocked position at an angle below parallel to a horizontal plane of the upper portion 602. An insert 400 may be disposed within a cavity and have a flat top surface, having no recess to create an edge to secure a fishing line. The top of the cam 500 may not be flush with the top of fly fishing camlock device upper portion 602, being seated lower in an upper portion.

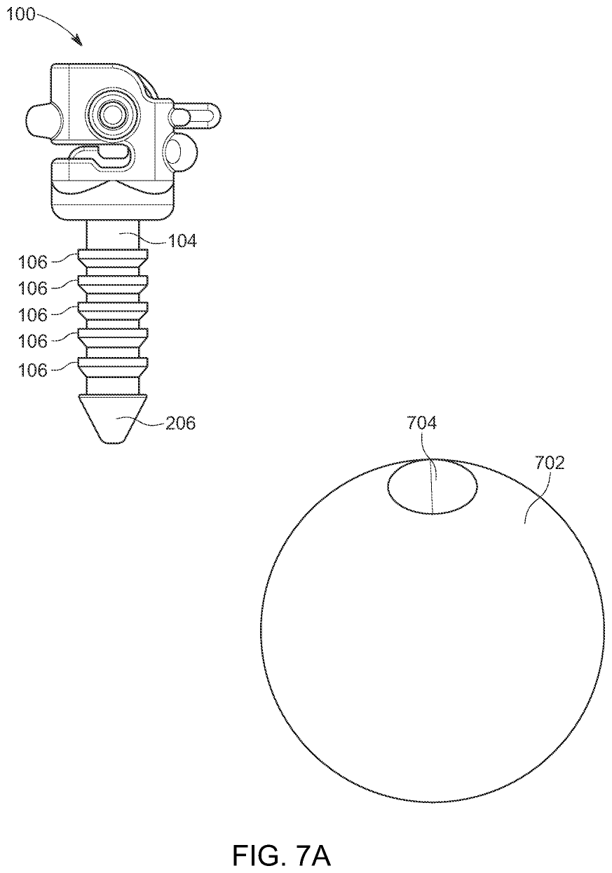

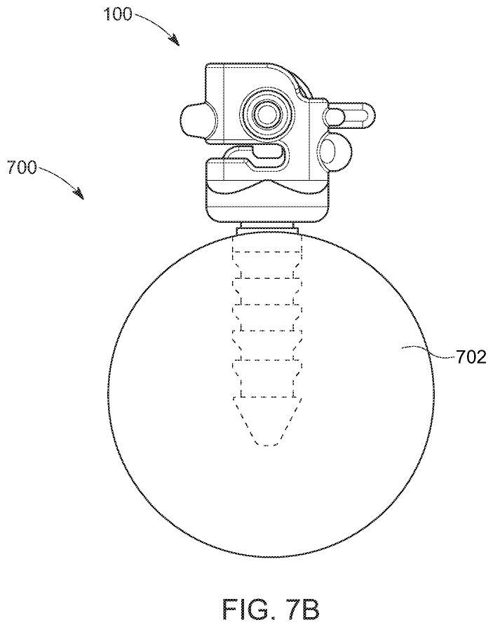

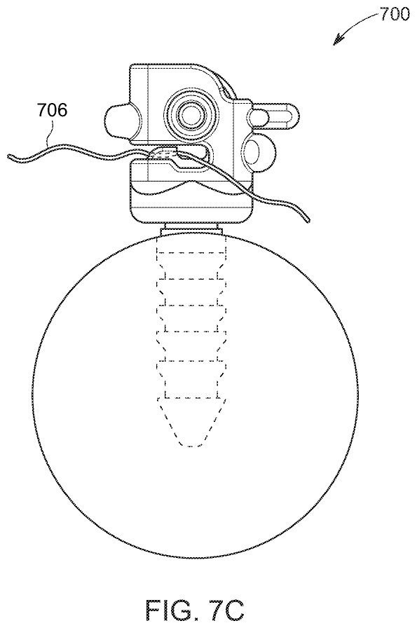

FIGS. 7A-7C show views of the fly fishing camlock system in accordance with the principles of the present disclosure. The fly fishing camlock device 100 may have a lower portion 104 having a plurality of rib ridges 106 and a wedge 206 at a distal tip of the device. These rib ridges and tip may work in tandem to attach a fly fishing camlock device 100 to a body 702. The body may have an opening 704 sized to receive the rib ridges 106 and wedge 206 and once inserted, the device may attach to the body 700 via an interference fit. The plurality of rib ridges 106 increase the surface area of the lower portion 104 to increase resistance when the lower portion 104 is inserted into the body 702. FIG. 7B shows a view of the fly fishing camlock device 100 after insertion into a body 702 to form a complete fly fishing camlock system 700. FIG. 7C shows a fly fishing camlock system 700 attached to a fishing line 706 in an unlocked position.

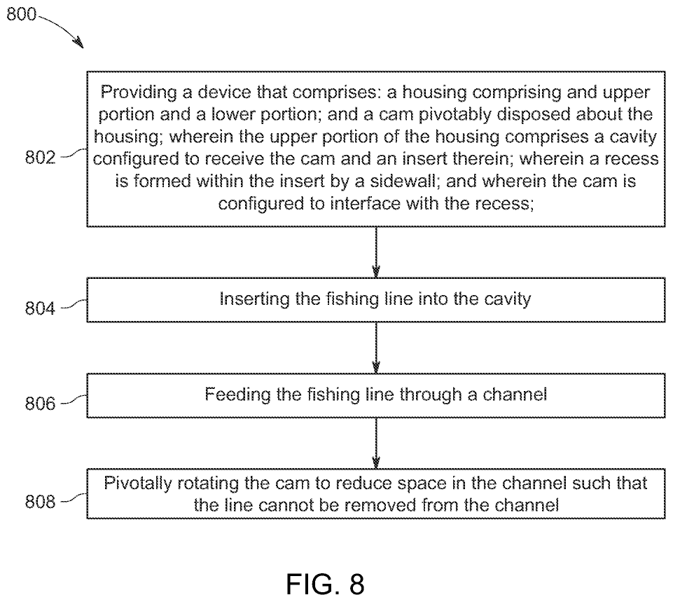

FIG. 8 illustrates a method 800 for attaching a fly fishing camlock system to a fishing line. A user may provide at 802 a device that comprises a housing comprising an upper portion and a lower portion; a cam pivotably disposed about the housing; wherein the upper portion of the housing comprises a cavity opening configured to receive the cam therein; and wherein the cam is configured to interface with the recess and to rotate from an unlocked position to a locked position and from the locked position to the unlocked position. At 804 a user may insert the fishing line into the cavity. At 806 a user may feed the fishing line through a channel. At 808 a user may pivotally rotate the cam to reduce space in the channel such that the line cannot be removed from the channel.

In accordance with the features and combinations described above, a useful method of securing a fishing line to a fishing implement may include the steps of:
1. providing a device according to the disclosure,
2. feeding a line through a cavity,
3. feeding a line through a channel, and
4. rotating a cam such that a cam arm interfaces with the channel.

Other Steps in the Method May Include:
1. to un-attach the device, rotate the cam such that the cam arm is no longer interfacing with the channel,
2. pulling the line free from the channel, and
3. removing the line from the cavity.

### EXAMPLES

The following examples pertain to feature of further implementations of the disclosure:

Example 1 is a device. The device comprises a housing and a cam. The housing comprises an upper portion and a lower portion. The cam is pivotably disposed within the housing. The upper portion comprises a cavity opening configured to receive the fishing line therethrough and a cavity configured to receive the cam therein. The cam is configured to interface with the cavity opening and to rotate from an unlocked position to a locked position and from the locked position to the unlocked position.

Example 2 is a device as in Example 1, wherein the upper portion of the housing further comprises an insert that is located within the cavity opening; wherein the recess is formed by a sidewall of the insert; and wherein the cam is configured to interface with the recess to lock the fishing line in the recess when the cam is in the locked position and to unlock the fishing line from the recess when the cam is in the unlocked position.

Example 3 is a device as in Examples 1 or 2, wherein the cam further comprises a cam body having a curved surface and a substantially flat surface opposite the curved surface; a cam lever; and a cam arm; wherein the cam is pivotably rotatable such that the cam body interfaces with the recess.

Example 4 is a device as in any of Examples 1-3, wherein the curved surface of the cam body faces and at least partially resides within the recess thereby reducing space between the recess and the curved surface of the cam body when the cam is in the locked position such that the fishing line cannot be removed from the recess when the cam is in the locked position.

Example 5 is a device as in any of Examples 1-4, wherein the flat surface of the cam body is located in a plane that is substantially perpendicular to a longitudinal axis of the lower portion of the housing when the cam is in the unlocked position such that the cam body does not interfere with the recess thereby allowing the fishing line to move freely within the recess in at least one dimension when the cam is in the unlocked position.

Example 6 is a device as in any of Examples 1-5 wherein the upper portion comprises a cavity opening configured to receive the fishing line therethrough; and wherein the insert further comprises a curved surface that forms a portion of the cavity opening, wherein the curved surface is configured to guide the fishing line through the cavity opening of the cavity and into the recess of the insert.

Example 7 is a device as in any of Examples 1-6 wherein the sidewall of the insert forms an edge, such that when the fishing line is inserted into the recess the fishing line is at least partially maintained within the recess by the edge, such that the sidewall and the edge are configured to resist removal of the fishing line from the recess without an external force being exerted on the fishing line to remove the fishing line from the recess.

Example 8 is a device as in any of Examples 1-7 wherein the upper portion of the housing further comprises a protrusion extending laterally from a longitudinal axis of the upper portion of the housing; wherein the protrusion comprises a channel extending through the protrusion along a substantially longitudinal axis of the upper portion such that a fishing line exits the channel parallel to the substantially longitudinal axis of the upper portion of the housing; and wherein the cam arm is disposed within the channel.

Example 9 is a device as in any of Examples 1-8 wherein the cam arm is positioned within the channel such that the cam arm obstructs the channel to prevent a fishing line therein from being removed when the cam is in the locked position.

Example 10 is a device as in any of Examples 1-9 wherein the cam arm is positioned within the channel such that the cam arm does not obstruct the channel to allow a fishing line to be removed when the cam is in the unlocked position.

Example 11 is a device as in any of Examples 1-10 wherein the lower portion of the housing further comprises a plurality of rib ridges and a wedge.

Example 12 is a device as in any of Examples 1-11 wherein the plurality of rib ridges are spaced along a length of the lower portion of the housing and wherein the wedge is located at a distal end of the lower portion of the housing.

Example 13 is a system. The system comprises a fishing implement body and a device for attaching a fishing line to the fishing implement body. The device comprises a housing comprising an upper portion and a lower portion and a cam pivotably disposed about the housing. The upper portion of the housing comprises a cavity opening configured to receive a line therein and a cavity configured to receive the cam therein. The cam is configured to interface with the cavity opening and to rotate from an unlocked position to a locked position and from a locked position to an unlocked position.

Example 14 is a system as in Example 13 wherein the upper portion of the housing further comprises an insert that is located within the cavity opening; wherein the recess is formed by a sidewall of the insert; and wherein the cam is configured to interface with the recess to lock the fishing line in the recess when the cam is in the locked position and to unlock the fishing line from the recess when the cam is in the unlocked position.

Example 15 is a system as in Examples 13 or 14 wherein the cam further comprises a cam body having a curved surface and a substantially flat surface opposite the curved surface; a cam lever; and a cam arm; wherein the cam is pivotably rotatable such that the cam body interfaces with the recess.

Example 16 is a system as in any of Examples 13-15 wherein the curved surface of the cam body faces and at least partially resides within the recess thereby reducing space between the recess and the curved surface of the cam body when the cam is in the locked position, such that the fishing line cannot be removed from the recess when the cam is in the locked position.

Example 17 is a system as in any of Examples 13-16 wherein the flat surface of the cam body is located in a plane that is substantially perpendicular to a longitudinal axis of the lower portion of the housing when the cam is in the unlocked position, such that the cam body does not interfere with the recess thereby allowing the fishing line to move freely within the recess in at least one dimension when the cam is in the unlocked position.

Example 18 is a system as in any of Examples 13-17 wherein the upper portion comprises a cavity opening configured to receive the fishing line therethrough; and wherein the insert further comprises a curved surface that forms a portion of the cavity opening, wherein the curved surface is configured to guide the fishing line through the cavity opening of the cavity and into the recess of the insert.

Example 19 is a system as in any of Examples 13-18 wherein the sidewall of the insert forms an edge, such that when the fishing line is inserted into the recess the fishing line is at least partially maintained within the recess by the edge, such that the sidewall and the edge are configured to resist removal of the fishing line from the recess without an external force being exerted on the fishing line to remove the fishing line from the recess.

Example 20 is a system as in any of Examples 13-19 wherein the upper portion of the housing further comprises a protrusion extending laterally from a longitudinal axis of the upper portion; wherein the protrusion comprises a channel extending through the protrusion along a substantially longitudinal axis of the upper portion such that a fishing line exits the channel parallel to the substantially longitudinal axis of the upper portion; and wherein the cam arm is disposed within the channel.

Example 21 is a system as in any of Examples 13-20 wherein the cam arm is positioned within the channel such that the cam arm obstructs the channel to prevent a fishing line therein from being removed when the cam is in the locked position.

Example 22 is a system as in any of Examples 13-21 wherein the cam arm is positioned within the channel such that the cam arm does not obstruct the channel to allow a fishing line to be removed when the cam is in the unlocked position.

Example 23 is a system as in any of Examples 13-22 wherein the lower portion of the housing of the device further comprises a plurality of rib ridges and a wedge.

Example 24 is a system as in any of Examples 13-23 wherein the plurality of rib ridges are spaced along a length of the lower portion of the housing and wherein the wedge is located at a distal end of the lower portion of the housing.

Example 25 is a system as in any of Examples 13-24 wherein the plurality of rib ridges and the wedge interface with the opening of the body to be inserted into the body and are secured in an interference fit.

Example 26 is a system as in any of Examples 13-25 wherein the body comprises a buoyant material.

Example 27 is a system as in any of Examples 13-26 wherein the buoyant material is a foam.

Example 28 is a method for using a device with a fishing line and a fishing implement. The steps comprise providing a device that comprises a housing comprising an upper portion and a lower portion and a cam pivotably disposed about the housing. The upper portion of the housing comprises a cavity opening configured to receive the fishing line therethrough and a cavity configured to receive the cam therein. The cam is configured to interface with the recess and to rotate from an unlocked position to a locked position to and from the locked position to the unlocked position. The steps also comprise inserting the fishing line into the cavity, feeding the fishing line through a channel and pivotally rotating the cam to reduce space in the channel such that the line cannot be removed from the channel.

Example 29 is a method as in Example 28 further comprising pivotally rotating the cam to expand space in the channel such that the fishing line can be removed from the channel, removing the line from the channel, and removing the fishing line from the cavity opening.

Those having ordinary skill in the relevant art will appreciate the advantages provided by the features of the disclosure. For example, it is a potential feature of the disclosure to provide a fly fishing camlock device that is simple in design and in manufacture. Another potential feature of the disclosure may be to provide such a fly fishing camlock device comprising a single piece or multiple pieces together having a hollow interior. It is yet another potential feature of the disclosure, in accordance with one aspect thereof, to provide a fly fishing camlock device that may be attached to a fishing hook for being tied into a fishing fly.

In the foregoing Detailed Description of the Disclosure, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

The foregoing description has been presented for the purposes of illustration and description. It is not intended to be exhaustive or to limit the disclosure to the precise form disclosed. Many modifications and variations are possible in light of the above teaching. Further, it should be noted that any or all the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A device comprising:
a housing comprising and upper portion and a lower portion for attaching a fishing line to a fishing implement; and
a cam pivotably disposed about the housing;
wherein the upper portion of the housing comprises a cavity configured to receive the cam therein; and
wherein the cam is configured to rotate within the cavity from an unlocked position to a locked position and from the locked position to the unlocked position.

2. The device of claim 1, wherein the upper portion of the housing further comprises
an insert that is located within the cavity;
wherein a recess is formed by a sidewall of the insert; and
wherein the cam is configured to interface with the recess to lock the fishing line in the recess when the cam is in the locked position and to unlock the fishing line from the recess when the cam is in the unlocked position.

3. The device of claim 2, wherein the cam further comprises:
a cam body having a curved surface and a substantially flat surface opposite the curved surface;
a cam lever; and
a cam arm;
wherein the cam is pivotably rotatable such that the cam body interfaces with the recess.

4. The device of claim 3, wherein the curved surface of the cam body faces and at least partially resides within the recess thereby reducing space between the recess and the curved surface of the cam body when the cam is in the locked position, such that the fishing line cannot be removed from the recess when the cam is in the locked position.

5. The device of claim 3, wherein the flat surface of the cam body is located in a plane that is substantially perpendicular to a longitudinal axis of the lower portion of the housing when the cam is in the unlocked position, such that the cam body does not interfere with the recess thereby allowing the fishing line to move freely within the recess in at least one dimension when the cam is in the unlocked position.

6.

6. The device of claim 2, wherein the upper portion comprises a cavity opening configured to receive the fishing line therethrough; and wherein the insert further comprises a curved surface that forms a portion of the cavity opening, wherein the curved surface is configured to guide the fishing line through the cavity opening of the cavity and into the recess of the insert.

7. The device of claim 2, wherein the sidewall of the insert forms an edge, such that when the fishing line is inserted into the recess the fishing line is at least partially maintained within the recess by the edge, such that the sidewall and the edge are configured to resist removal of the fishing line from the recess without an external force being exerted on the fishing line to remove the fishing line from the recess.

8. The device of claim 3, wherein the upper portion of the housing further comprises:
a protrusion extending laterally from a longitudinal axis of the upper portion of the housing;
wherein the protrusion comprises a channel extending therethrough such that a fishing line exits through the channel in a direction that is substantially parallel to the longitudinal axis of the lower portion; and
wherein the cam arm is disposed within the channel.

9. The device of claim 8, wherein the cam arm is positioned within the channel such that the cam arm obstructs the channel to prevent a fishing line therein from being removed when the cam is in the locked position.

10. The device of claim 8, wherein the cam arm is positioned within the channel such that the cam arm does not obstruct the channel to allow a fishing line to be removed when the cam is in the unlocked position.

11. The device of claim 1, wherein the lower portion of the housing further comprises:
a plurality of rib ridges; and
a wedge.

12. The device of claim 11, wherein the plurality of rib ridges are spaced along a length of the lower portion of the housing and wherein the wedge is located at a distal end of the lower portion of the housing.

13. A system comprising:
a fishing implement body; and
a device for attaching a fishing line to the fishing implement body, the device comprising:
a housing comprising and upper portion and a lower portion; and
a cam pivotably disposed about the housing;
wherein the upper portion of the housing comprises a cavity configured to receive the cam therein; and
wherein the cam is configured to rotate within the cavity from an unlocked position to a locked position and from the locked position to the unlocked position.

14. The system of claim 13, wherein the upper portion of the housing further comprises an insert that is located within the cavity opening;
wherein the recess is formed by a sidewall of the insert; and
wherein the cam is configured to interface with the recess to lock the fishing line in the recess when the cam is in the locked position and to unlock the fishing line from the recess when the cam is in the unlocked position.

15. The system of claim 14, wherein the cam further comprises:
a cam body having a curved surface and a substantially flat surface opposite the curved surface;
a cam lever; and
a cam arm;
wherein the cam is pivotably rotatable such that the cam body interfaces with the recess.

16. The system of claim 15, wherein the curved surface of the cam body faces and at least partially resides within the recess thereby reducing space between the recess and the curved surface of the cam body when the cam is in the locked position, such that the fishing line cannot be removed from the recess when the cam is in the locked position.

17. The system of claim 15, wherein the flat surface of the cam body is located in a plane that is substantially perpendicular to a longitudinal axis of the lower portion of the housing when the cam is in the unlocked position, such that the cam body does not interfere with the recess thereby allowing the fishing line to move freely within the recess in at least one dimension when the cam is in the unlocked position.

18. The system of claim 14, wherein the upper portion comprises a cavity opening configured to receive the fishing line therethrough; and wherein the insert further comprises a curved surface that forms a portion of the cavity opening, wherein the curved surface is configured to guide the fishing line through the cavity opening of the cavity and into the recess of the insert.

19. The system of claim 14, wherein the sidewall of the insert forms an edge, such that when the fishing line is inserted into the recess the fishing line is at least partially maintained within the recess by the edge maintained within the recess by the edge, such that the sidewall and the edge are configured to resist removal of the fishing line from the recess without an external force being exerted on the fishing line to remove the fishing line from the recess.

20. The system of claim 15, wherein the upper portion of the housing further comprises:
a protrusion extending laterally from a longitudinal axis of the upper portion;
wherein the protrusion comprises a channel extending therethrough such that a fishing line exits through the channel in a direction that is substantially parallel to the longitudinal axis of the lower portion; and
wherein the cam arm is disposed within the channel.

21. The system of claim 20, wherein the cam arm is positioned within the channel such that the cam arm obstructs the channel to prevent a fishing line therein from being removed when the cam is in the locked position.

22. The system of claim 20, wherein the cam arm is positioned within the channel such that the cam arm does not obstruct the channel to allow a fishing line to be removed when the cam is in the unlocked position.

23. The system of claim 13, wherein the lower portion of the housing of the device further comprises:
a plurality of rib ridges; and
a wedge.

24. The system of claim 23, wherein the plurality of rib ridges are spaced along a length of the lower portion of the housing and wherein the wedge is located at a distal end of the lower portion of the housing.

25. The system of claim 23, wherein the plurality of rib ridges and the wedge interface with the opening of the body to be inserted into the body and are secured in an interference fit.

26. The system of claim 13, wherein the fly fishing implement body comprises a buoyant material.

27. The system of claim 26, wherein the buoyant material is a foam.

28. A method for a using a device with a fishing line and a fishing implement, the steps comprising:
providing a device that comprises:
a housing comprising and upper portion and a lower portion; and
a cam pivotably disposed about the housing;
wherein the upper portion of the housing comprises a cavity configured to receive the cam and an insert therein;
wherein a recess is formed within the insert by a sidewall; and
wherein the cam is configured to interface with the recess;
inserting the fishing line into the cavity;
feeding the fishing line through a channel; and
pivotally rotating the cam to a locked position thereby locking the fishing line within the recess of the insert and reducing space in the channel such that the fishing line cannot be removed from the recess and the channel.
The method of claim 28, further comprising:
pivotally rotating the cam to an unlocked position thereby enlarging a space in the channel such that the fishing line can be removed from the channel;
removing the fishing line from the channel; and
removing the fishing line from the recess.
